(19) United States
(12) Patent Application Publication
(10) Pub. No.: US 2002/0196623 A1
(43) Pub. Date: Dec. 26, 2002

(54) High efficient tubular light emitting cylinder

(75) Inventor: George Yen, Taipei (TW)

Correspondence Address: DOUGHERTY & TROXELL, SUITE1404, 5205 LEESBURG PIKE, FALLS CHURCH, VA, 22041, US

(73) Assignee: Star-Reach Corporation

(21) Appl. No.: 09/929,011

(22) Filed: Aug. 15, 2001

(30) Foreign Application Priority Data
Jun. 21, 2001 (TW) 090210452

(51) Int. Cl. F21V 13/04; F21V 29/00

(52) U.S. Cl. 362/245; 362/246; 362/240; 362/800; 362/294

(57) ABSTRACT

A high efficient tubular light emitting cylinder is disclosed. The high efficient tubular light emitting cylinder is especially an LED tubular light emitting cylinder which can be installed and maintained easily and has a high light emitting efficiency. The tubular light emitting cylinder has a plurality of light emitting segments. The light emitting segments are connected in series. The connected light emitting segments are installed in a tubular light emitting cylinder for improving the light emitting efficiency. The light emitting segments can be taken out from the light emitting cylinder easily so that the light emitting cylinder can be installed and maintained easily and conveniently.

### FIELD OF THE INVENTION

The present invention relates to a light source, and particular to a high efficient tubular light emitting cylinder having a uniform light emitting surface and smooth light.

### BACKGROUND OF THE INVENTION

Conventionally, a tubular light emitting device is a special lamp device. As illustrated in FIG. 1, a prior art product is shown. In the prior art, a point light source (bulb) (105) is installed at one or two ends of a tubular light emitting cylinder 101. By the reflecting layers 103 and 104, light mixing layer 106 and diffusing layer 102 in the cylinder. The point light source will generate a soft and smooth plane light source. Furthermore, since the light source 105 is arranged at one end of a tubular light emitting cylinder 101. As described above, the conventional tubular light emitting cylinder can be repaired conveniently.

As shown in the figure, 1Lx is incident light, 1Rx is reflective light and 1Tx is transmitting light. Since the conventional light source is too hot, the materials in the light emitting cylinder may change their quality (about through one year). Therefore, recently, in some products, LEDs are used as a light source, but the light emitting efficiency is low. Referring to FIG. 1, light source 105 emits light, then is reflected many times and then transmits out of the light emitting cylinder. In this process, a large amount of light is lost. Furthermore, since the transmitting direction of the light source have an angle of about 180 degrees with the light emitting surface. It is apparent that the light emitting efficiency is low.

### SUMMARY OF THE INVENTION

Accordingly, the primary object of the present invention is to provide a high efficient tubular light emitting cylinder, wherein a light emitting device is a long strip body and is installed in the light emitting cylinder so that the light emitting efficiency is about 5 to 10 times of the conventional one. This is because the path of a long strip light emitting device is shorter than the prior art and further the number of times of reflection are reduced greatly. Therefore, light efficiency is improved greatly. Therefore, by the diffusing property of a light emitting cylinder, a uniform light emitting surface and smooth light are acquired.

The present invention provides a high efficient tubular light emitting cylinder. The high efficient tubular light emitting cylinder is especially an LED tubular light emitting cylinder which can be installed and maintained easily and has a high light emitting efficiency. The structure of tubular light emitting cylinder has a plurality of light emitting segments. The light emitting segments are connected in series. The connected light emitting segments are installed in a tubular light emitting cylinder for improving the light emitting efficiency. The light emitting segments can be taken out from the light emitting cylinder easily so that the light emitting device can be installed and maintained easily and conveniently.

The various objects and advantages of the present invention will be more readily understood from the following detailed description when read in conjunction with the appended drawing.

### BRIEF DESCRIPTION OF THE DRAWINGS

FIG. 1 is a front view and lateral view of a conventional tubular light emitting device.

FIG. 2 is a front view and lateral view of the tubular light emitting cylinder of the present invention.

FIG. 3 is a schematic view showing a structure of the tubular light emitting cylinder according to the present invention.

FIG. 4 is a perspective view showing the light emitting segment of the tubular light emitting cylinder in an embodiment of the present invention.

FIG. 5 is a perspective view showing the tubular light emitting cylinder of the embodiment according to the present invention.

FIG. 6 is a lateral view of the tubular light emitting cylinder in an embodiment of the present invention.

### DETAILED DESCRIPTION OF THE PREFERRED EMBODIMENTS

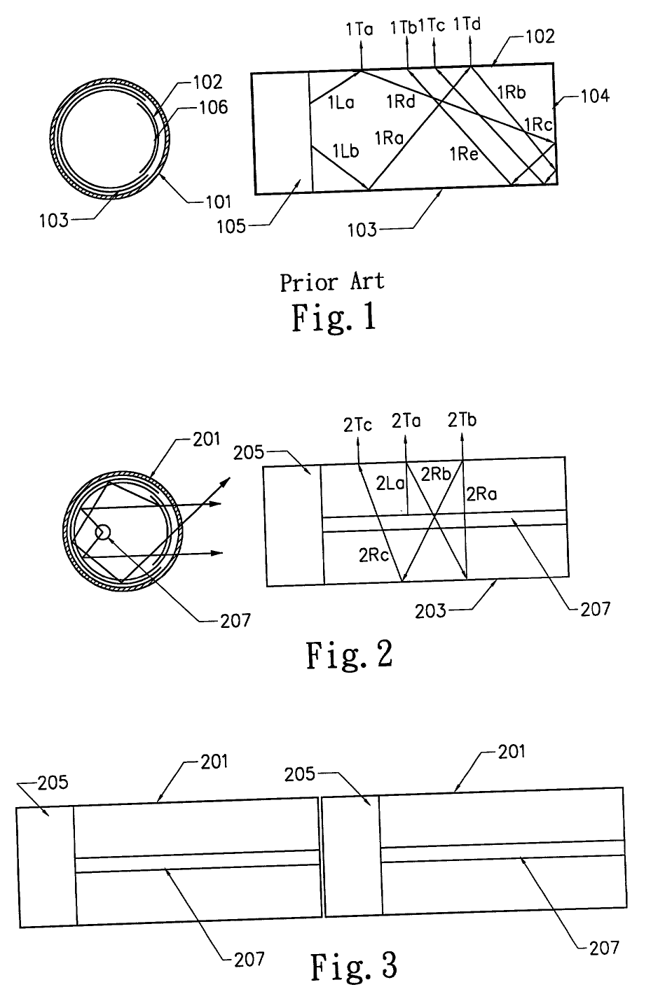

Referring to FIG. 2, in the present invention, strip light sources 207 are arranged in an light emitting cylinder 201 at the same direction. The light emitting cylinder 201 has a diffusing layer 202, a reflecting layer 203, and a light mixing layer 206. Therefore, the light of the strip light source 207 transmits out of the light emitting cylinder 201 with an angle of approximate 90 degrees. The reflection is reduced greatly. For a conventional lateral light source (referring to FIG. 1), light transmits out through the light mixing layer at an angle of approximate 180 degrees. The present invention is more efficient than the prior art. In FIG. 2, the light 2Lx of FIG. 2 is incident light, 2Rx is reflective light and 2Tx is transmitting light.

To change light source as a long strip is another problem, since if it is desired to update the light source, a large space is necessary from two long cylinders (referring to FIG. 3). Therefore, the feature of an optic long cylinder is unnecessary.

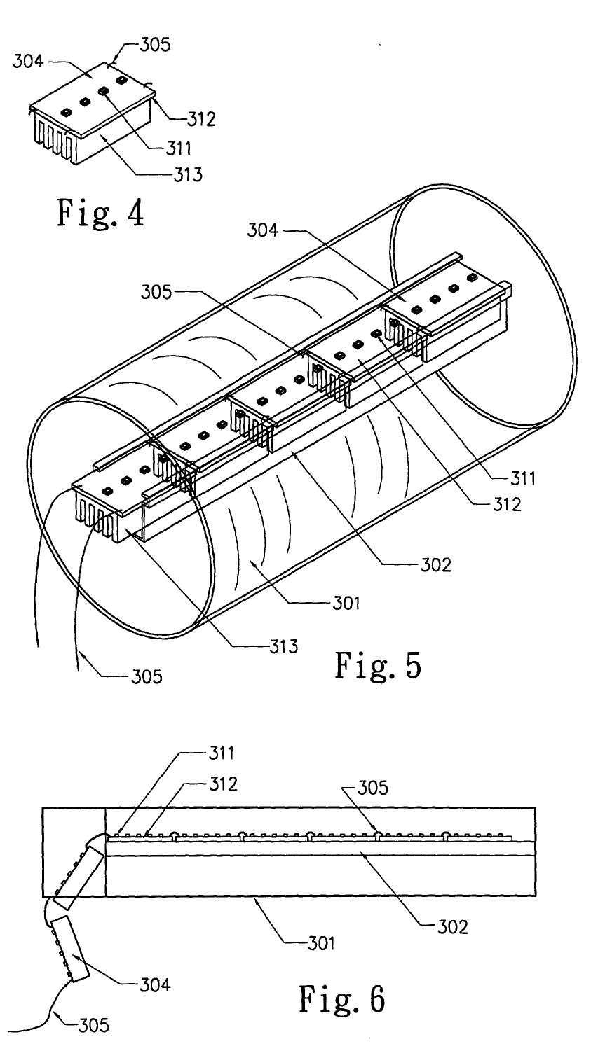

To resolve above problem, the present invention provides a high efficient tubular light emitting cylinder, as illustrated in FIGS. 4, 5 and 6. In this tubular light emitting cylinder, the property of an LED is used. At the side of the light emitting cylinder 301 having a light source 303, a plurality of LEDs 311 are installed in a circuit board 312 so as to form a light emitting segment 304. A plurality of light emitting segments are connected as a long strip by an electric wire 305 or a soft circuit board.

Above light emitting segment 304 includes a circuit board 312. A back side of the circuit board 312 is formed with a metal heat dissipating device 313 with a plurality of trenches thereon. Besides, the light emitting cylinder 301 is formed with a track 302. Therefore, each light emitting segment 304 may easily slide into or slide out of the light emitting cylinder 301. FIG. 6 is a schematic view showing the operation of installing the present invention.

Of course, a general long strip light source may be assembled by the present invention. However, since the LEDs are point source. The illumination and emitting angle of each LED are different. Therefore, by the diffusing property of the light emitting cylinder, a uniform light emitting area is obtained and a soft light emitting effect is achieved.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A high efficient tubular light emitting cylinder having a plurality of strip light sources; the strip light source being placed in a light emitting cylinder, the light emitting cylinder having a diffusing layer, a reflecting layer, and a light mixing layer; thereby, light of the strip light sources emitting out of the light emitting cylinder with an angle of approximate 90 degrees to a surface of the light emitting cylinder, thereby, a uniform light emitting area and a soft light effect being achieved.

2. The high efficient tubular light emitting cylinder as claimed in claim 1, wherein the strip light source is formed by installing a plurality of LEDs on a circuit board so as to acquire a light emitting segment, and then connecting a plurality of light emitting segments by an electric wire or a soft circuit board.

3. The high efficient tubular light emitting cylinder as claimed in claim 1, wherein each light emitting segment is attached to an aluminum metal heat dissipating device with a plurality of trenches.

4. The high efficient tubular light emitting cylinder as claimed in claim 1, wherein a track is formed in the tubular light emitting cylinder; thereby, each light emitting segment is installed in the track and can be taken out from the track.
